(19) United States
(12) Patent Application Publication
(10) Pub. No.: US 2022/0123659 A1
(43) Pub. Date: Apr. 21, 2022

(54) PV POWER CONVERTER

(71) Applicant: ABB SCHWEIZ AG, Baden (CH)

(72) Inventors: Xiaobo YANG, Beijing (CN); Zhuoran LIU, Beijing (CN); Xing HUANG, Beijing (CN)

(21) Appl. No.: 17/423,821

(22) PCT Filed: Jan. 18, 2019
(86) PCT No.: PCT/CN2019/072328

§ 371 Date: Jul. 16, 2021

(51) Int. Cl. H02M 3/335; H02M 1/32; H02S 40/32

(52) U.S. Cl. CPC H02M 3/33573; H02S 40/32; H02M 1/32

(57) ABSTRACT

a A PV power converter includes a transformer, a first output port a second output port, and a first power conversion circuit configured to convert power from PV array into AC power. The first power conversion circuit has a first input terminal and a second input terminal; and a first output terminal and a second output terminal. The PV power converter also includes a second power conversion circuit being configured to convert power from the transformer into DC power. The second power conversion circuit has a first input end and a second input end electrically coupled to secondary winding of the transformer, and a first output end electrically coupled to the first output port and a second output end electrically coupled to the first input terminal of the first power conversion circuit. The PV power converter also includes a first power switch.

### TECHNICAL FIELD

This invention relates generally to PV (photovoltaic) power conversion, and more particularly, to protection of a fault occurring to the PV power conversion device.

### BACKGROUND ART

Photovoltaic system is quite popular as a renewable source in many applications. Its PV module has the maximum power point (MPP) phenomenon, which means the PV module outputs the maximum power at a certain point that is not the end of the operation range. Moreover, the output power of the PV module can vary with the temperature and the irradiation. FIG. 1A is a P-V curve of a PV module illustrating the MPP phenomenon. As show in FIG. 1A, an output power of PV module increases with an increase of the PV module output voltage in a direction towards the MPP in region A. In contrast, an output power of PV module decreases with an increase of the PV module output voltage in a direction away from the MPP in region B. FIG. 1B schematically depicts different P-V curves of a PV module for various operational conditions. As shown in FIG. 1B, the location of MPP varies with the operational conditions of the solar panel, such as its temperature and the irradiation intensity. For this reason, photovoltaic systems typically comprise a control system that varies the match between the load and impedance of its converter circuit connected to the PV module in order to ensure a switching between modes of voltage source control and maximum power point track control. FIG. 1A also indicate operating points, A and B, of a PV module, which operating points A, B, differ from the maximum power point (MPP) of the PV module. When tracking the MPP (MPPT), voltage levels (such as A and B) that for the current state differs from the MPP are adjusted to match the MPP.

The key components inside a PV station are DC optimizers. DC optimizer (DCO) is a DC to DC converter technology to realize maximum power point tracking (MPPT) of PV modules connected to the input of DC optimizer. The DC optimizer can be used for both PV module level (namely panel level DC optimizer) and PV string level. For both cases, there will be an input DC bus and an output DC bus formed at the input terminal and the out terminal of the DC optimizer.

Usually the converter topology of the DC optimizer is the so called full power converter. Conventional technology is Boost converter. For certain application, a galvanic isolated two stage (DC/AC/DC) converter will be also used.

However, the full power converter will process all the power from input to output, the total conversion loss of the system is high, even with high efficiency converters. To increase the competition of the DC optimizer solution, new DC/DC topology with higher efficiency and low cost is needed. Among different DC/DC converter solutions, partial power converter (PPC) is presented as strong candidates to improve the overall efficiency and power density of the DC optimizer. The main goal of PPC is to process just small amount of the total power. Various studies have shown that PPC in PV system can realize better efficiency and reduced power rating compared with standard full power processing topologies. This is described in J. R. R. Zientarski, M. L. S Martins, J. R. Pimheiro et al, “Series-connected partial power converts applied to PV systems: A design approach based on step-up/down voltage regulation range,” IEEE Trans. on Power Electronics. 2017.

Though the PPC provides high system efficiency, it has disadvantage during input DC bus short circuit fault: when an input DC bus short circuit fault happens, as shown in FIG. 2A, the rectifier will have to withstand the voltage of Vₒᵤₜ, i.e. V_{c}=Vₒᵤₜ, wherein V_{c} is the voltage at rectifier. The output DC bus voltage Vₒᵤₜ is usually much higher than the normal operation voltage of PPC. In order to avoid the damage of rectifier from overvoltage, one solution is to design the voltage rating of the rectifier according to the output DC voltage, which will increase the total cost of the PPC.

Furthermore, the PPC also has disadvantages during occurrence of short-circuit to the outputs of PPC as shown in FIG. 2, in particular when the rectifier is a diode rectifier. When an output DC bus short circuit fault happens, as shown in FIG. 2B, the rectifier will maintain conducting due to the diode rectifier characteristic. Though the fault current injected from DC input side (PV panel) is not high, it hinders the DC fault current arc extinguishing, which may bring additional damage on the cable insulation at output DC bus.

### BRIEF SUMMARY OF THE INVENTION

According an aspect of present invention, it provides a PV power converter including: a transformer, a first output port and a second output port, a first power conversion circuit being configured to convert power from PV array into AC power. The first power conversion circuit has a first input terminal and a second input terminal being configured to be electrically coupled to outputs of PV array with the second input terminal electrically coupled to the second output port; and a first output terminal and a second output terminal electrically coupled to primary winding of the transformer. The PV power converter also includes a second power conversion circuit being configured to convert power from the transformer into DC power. The second power conversion circuit has a first input end and a second input end electrically coupled to secondary winding of the transformer, and a first output end electrically coupled to the first output port and a second output end electrically coupled to the first input terminal of the first power conversion circuit. The PV power converter also includes a first power switch being arranged electrically between either of the first input terminal and the second input terminal and either of the first output port and the second output port, having a conducting direction allowing unidirectional current flow.

By using the embodiments of present invention, the voltage applied to the DC side of the second power conversion circuit by the DC voltage across the first output port and a second output port will be shared between the first power switch and those diodes in side of the second power conversion circuit. The voltage stress on the DC side of the second power conversion circuit during the occurrence of short-circuit to the first input terminal and the second input terminal is reduced. Semiconductors with relatively low breakdown voltages for the second power conversion circuit can be selected, which decrease the converter cost and increase the power efficiency. The power losses from the additional first power switch is relatively low since it always works under conducting mode during normal operation.

When a short-circuit fault occurs to the first input terminal and the second input terminal of the first power conversion circuit, the first power switch as a unidirectional conducting device blocks the current flow. In general, the first power switch is arranged electrically between either of the first input terminal Tᵢₙ₁ and the second input terminal and either of the first output port and the second output port, having a conducting direction allowing unidirectional current flow.

Preferably, the second power conversion circuit uses a topology of rectifier having at least one leg of at least one power diode, and a breakdown voltage of the first power switch is selected such that a sum of the breakdown voltage of the first power and the breakdown voltage of the at least one leg, whichever is lower, is above a predetermined level. The at least one power diode may include only one power diode or a multiple of power diodes electrically coupled in series.

There is a trade-off between breakdown voltage rating and on-resistance of a power semiconductor device, because increasing the breakdown voltage by incorporating a thicker and lower doped drift region leads to a higher on-resistance. By properly selecting the parameters of breakdown voltage and on-resistance of the second power conversion circuit's diodes and the first power switch, the power losses from the forward-conduction of the first power switch can be limited and reverse-breakdown tolerance of the series-linked first power switch and second power conversion circuit can be improved.

### BRIEF DESCRIPTION OF THE DRAWINGS

The subject matter of the invention will be explained in more detail in the following text with reference to preferred exemplary embodiments which are illustrated in the drawings, in which:

FIG. 1A illustrates a P-V curve of a PV module illustrating the MPP phenomenon;

FIG. 1B schematically depicts different P-V curves of a PV module for various operational conditions;

FIG. 2A shows a partial power converter having short-circuit fault occurring at its output ports;

FIG. 2B shows a partial power converter having short-circuit fault occurring at its input ports;

FIG. 3 illustrates a PV power converter according to an embodiment of present invention;

FIG. 4 illustrates a PV power converter according to another embodiment of present invention;

FIG. 5 illustrates a PV power converter according to another embodiment of present invention; and

FIG. 6 illustrates a PV power converter according to another embodiment of present invention.

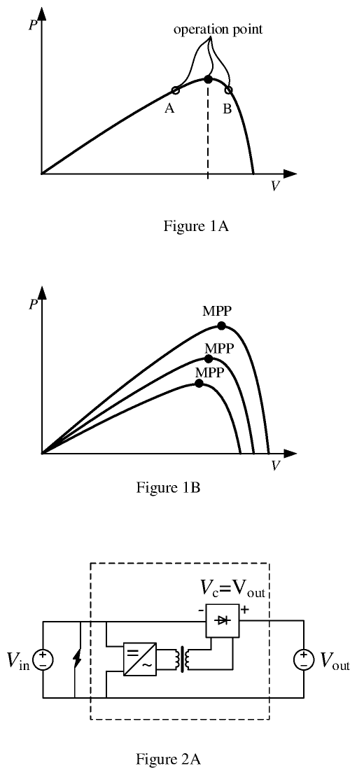

The reference symbols used in the drawings, and their meanings, are listed in summary form in the list of reference symbols. In principle, identical parts are provided with the same reference symbols in the figures.

### PREFERRED EMBODIMENTS OF THE INVENTION

In the following description, for purposes of explanation and not limitation, specific details are set forth, such as particular circuits, circuit components, interfaces, techniques, etc. in order to provide a thorough understanding of the present invention. However, it will be apparent to one skilled in the art that the present invention may be practiced in other embodiments that depart from these specific details. In other instances, detailed descriptions of well-known methods and programming procedures, devices, and circuits are omitted so not to obscure the description of the present invention with unnecessary detail.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

FIG. 3 is a circuit diagram of an exemplary embodiment of PV power converter. In the exemplary embodiment, PV power converter 2 is coupled between a PV array, for example, a PV array 20, and a DC link. A DC load 22 may be positioned across DC link. DC load 22 may include, but is not limited to, a battery charger and/or a grid-tied inverter, for example, DC to AC inverter. PV power converter 2 is also referred to herein as a partial power converter (PPC) since only a portion of the power output of PV array 20 is converted by PV power converter 2. The remaining portion of the power output of PV array 20 is provided to PV power converter 2, but not converted and/or processed by PV power converter 2 before being provided to DC link 21.

In the exemplary embodiment, PV power converter 2 is configured as a full-bridge-type converter that includes a transformer 23. Although illustrated as a full-bridge-type converter, any other suitable DC to DC converter arrangement may be used, such like push-pull-type converters. The transformer 23 includes a primary winding 23p and a secondary winding 23s. The PV power converter 2 also includes a first output port Pₒᵤₜ₁ and a second output port Pₒᵤₜ₂, through which power can be supplied from the PV power converter 2 to the DC load 22.

The PV power converter 2 also includes a first power conversion circuit 24 and a second power conversion circuit 25.

The first power conversion circuit 24 includes a first input terminal Tᵢₙ₁ and a second input terminal Tᵢₙ₂ configured to be electrically coupled to outputs of the PV array 20, and the second input terminal Tᵢₙ₂ is electrically coupled to the second output port Pₒᵤₜ₂ of the PV power converter 2. The first power conversion circuit also has a first output terminal Tₒᵤₜ₁ and a second output terminal Tₒᵤₜ₂ being electrically coupled to the primary winding 23p of the transformer 23. The first power conversion circuit 24 also includes at least one controllable semiconductor switch, for example four controllable semiconductor switches S₁, S₂, S₃, S₄. The controllable semiconductor switches S₁, S₂, S₃, S₄ may include, but are not limited to including, insulated-gate bipolar transistors (IGBTs), metal-oxide-semiconductor field-effect transistors (MOSFETs), or bipolar junction transistors (BJT) implemented with silicon or wide band gap materials (e.g., silicon carbide and/or gallium nitride). In the exemplary embodiment, the PV power converter 2 may include a controller (not shown) that controls operation of controllable semiconductor switches S₁, S₂, S₃, S₄ for converting power from the PV array 20 into AC power. For example, the controller may provide controllable semiconductor switches S₁, S₂, S₃, S₄. with control signals, wherein the duty cycle of the control signal controls a voltage output of PV power converter 2. In alternative embodiments, where the voltage of DC link 21 is regulated by the DC to AC inverter, PV power converter 2 regulates the input voltage of associated PV arrays, for example, PV array 20, by means of duty cycle control to extract maximum power from PV array 20.

The second power conversion circuit 25 includes a first input end Eᵢₙ₁ and a second input end Eᵢₙ₂ being electrically coupled to the secondary winding 23s of the transformer 23. The second power conversion circuit 25 also includes a first output end Eₒᵤₜ₁ and a second output end Eₒᵤₜ₂, and the first output end Eₒᵤₜ₁ is electrically coupled to the first output port Pₒᵤₜ₁ of the PV power converter 2 and the second output end Eₒᵤₜ₂ is electrically coupled to the first input terminal Tᵢₙ₁ of the first power conversion circuit 24. In the exemplary embodiment, the second power conversion circuit 25 also includes at least one semiconductor device, for example, a first diode D₁ and a second diode D₂. In the exemplary embodiment, a center tap Cₜ between two parts of the secondary winding 23s is electrically coupled to cathodes of the first diode D₁ and the second diode D₂, thus forming a half-bridge having two legs each with the respective diodes D₁, D₂. And, the anodes of them are electrically coupled to the first input end Eᵢₙ₁ and the second input end Eᵢₙ₂. A low-pass filter L, C is electrically inserted between the half-bridge and the output ends Eₒᵤₜ₁, Eₒᵤₜ₂. The primary section 23p and secondary section 23s are mutual-inductively coupled. In operation, a time-varying current flowing through primary winding 23p induces a voltage across secondary winding 23s, which is regulated by the second power conversion circuit 25 providing DC output at its first output end Eₒᵤₜ₁ and second output end Eₒᵤₜ₂.

The PV power converter 2 also includes a first power switch Q₁. In this embodiment as shown in FIG. 3, the first power switch Q₁ is electrically inserted between the first output end Eₒᵤₜ₁ of the second power conversion circuit 25 and the first output port Pₒᵤₜ₁ of the PV power converter 2, having a conducting direction allowing unidirectional current flow. When the PV power converter operates in normal condition, power flows from the PV array to the load at least via the first power switch Q₁ conducting the current. When a short-circuit fault occurs to the first input terminal Tᵢₙ₁ and the second input terminal Tᵢₙ₂ of the first power conversion circuit 24, the first power switch Q₁ as a unidirectional conducting device blocks the current flow. The first power switch Q₁ may include, but are not limited to including, insulated-gate bipolar transistors (IGBTs), metal-oxide-semiconductor field-effect transistors (MOSFETs), or bipolar junction transistors (BJT) implemented with silicon or wide band gap materials (e.g., silicon carbide and/or gallium nitride).

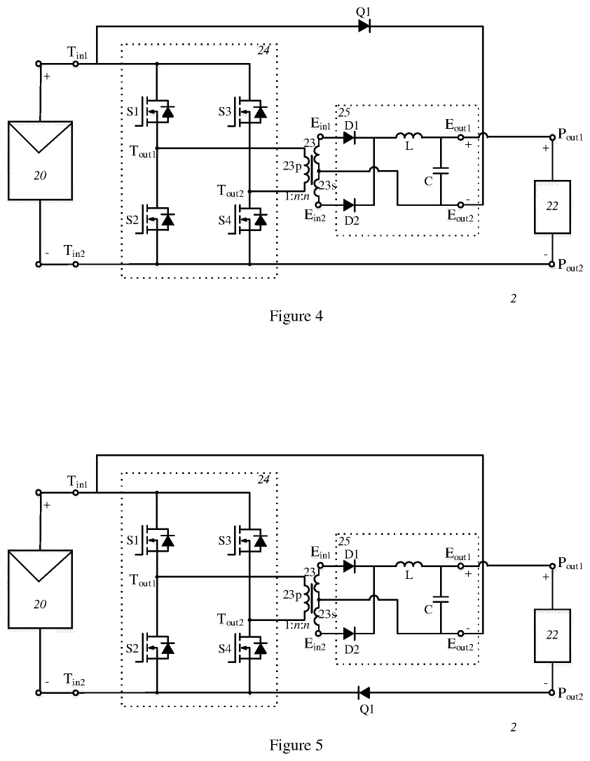

FIGS. 4 and 5 illustrate a PV power converter according to other embodiments of present invention. As alternative to the embodiment of FIG. 3, the first power switch Q₁ may be disposed at various locations, and by having these variants of the embodiment, When the PV power converter operates in normal condition, power flows from the PV array to the load at least via the first power switch Q₁ conducting the current. For example, as shown in FIG. 4, the first power switch Q₁ is arranged between the first input terminal Tᵢₙ₁ and the second output end Eₒᵤₜ₂; as shown in FIG. 5, the first power switch Q₁ is arranged between the second input terminal Tᵢₙ₂ and the second output port Pₒᵤₜ₂.

By using the embodiments of present invention, the voltage applied to the DC side of the second power conversion circuit 25 by the DC voltage across the first output port Pₒᵤₜ₁ and a second output port Pₒᵤₜ₂ will be shared between the first power switch Q₁ and those diodes in side of the second power conversion circuit 25. The voltage stress on the DC side of the second power conversion circuit during the occurrence of short-circuit to the first input terminal Tᵢₙ₁ and the second input terminal Tᵢₙ₂ is reduced. Semiconductors with relatively low breakdown voltages for the second power conversion circuit can be selected, which decrease the converter cost and increase the power efficiency. The power losses from the additional first power switch Q₁ is relatively low since it always works under conducting mode during normal operation.

When a short-circuit fault occurs to the first input terminal Tᵢₙ₁ and the second input terminal Tᵢₙ₂ of the first power conversion circuit 24, the first power switch Q₁ as a unidirectional conducting device blocks the current flow. In general, the first power switch Q₁ is arranged electrically between either of the first input terminal Tᵢₙ₁ and the second input terminal Tᵢₙ₂ and either of the first output port Pₒᵤₜ₁ and the second output port Pₒᵤₜ₂, having a conducting direction allowing unidirectional current flow.

The first power switch Q₁ as proposed topology can be a power diode, or as an alternatively to be replaced by a reverse-block power semiconductor, such as a reverse block IGBT. During normal operation, the reverse block IGBT is turned on. When input DC bus short circuit happens, the reverse block IGBT will withstand the output DC bus voltage together with rectifier.

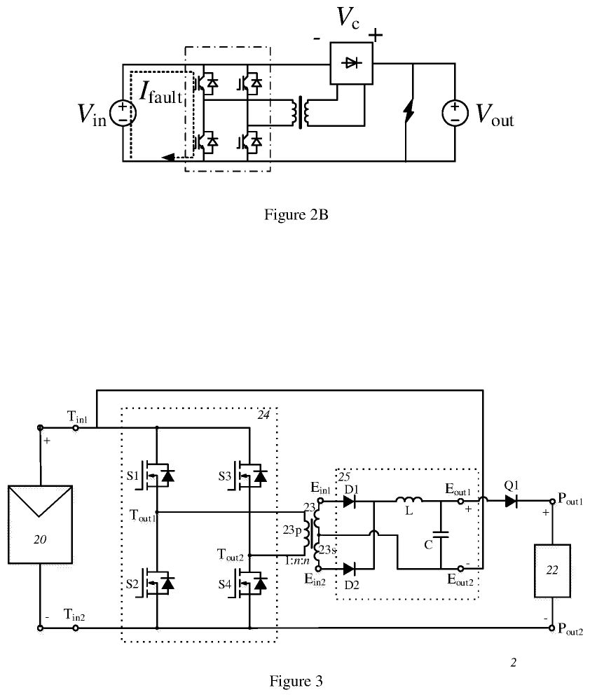

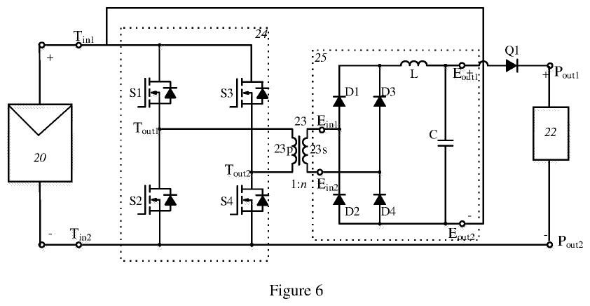

FIG. 6 illustrates a second power conversion circuit according to another embodiment of present invention. As shown in FIG. 6, different from that of FIG. 2, the second power conversion circuit 25 includes at least one semiconductor device, for example, a first diode D₁, a second diode D₂, a third diode D₃ and a fourth diode D₄. In the exemplary embodiment, the four diodes form a full-bridge rectifier, having two legs respective comprising the series-coupled first diode D₁ and the second diode D₂ and the series-coupled third diode D₃ and the fourth diode D₄. A connection point between the first diode D₁ and the second diode D₂ and a connection point between the third diode D₃ and the fourth diode D₄ are the first input end Eᵢₙ₁ and the second input end Eᵢₙ₂ of the second power conversion circuit. A low-pass filter L, C is electrically inserted between the full-bridge and the output ends Eₒᵤₜ₁, Eₒᵤₜ₂.

As for the second power conversion circuit 25 according to each of the embodiments of present invention, a breakdown voltage of the first power switch Q₁ is selected such that a sum of the breakdown voltage of the first power switch Q₁ and that of the at least one leg, whichever is lower, is above a predetermined level.

For example in FIG. 3, the first switch Q₁ has breakdown voltage V_{breakdown_Q1}, the diode D₁ on one of the legs has breakdown voltage V_{breakdown_D1}, the diode D₂ on the other of the legs has breakdown voltage V_{breakdown_D2}. Assuming V_{breakdown_D1}>V_{breakdown_D2} and assuming the PV power converter has an output rating as of Vₒᵤₜ, the V_{breakdown_Q1} is selected such that V_{breakdown_Q1}+V_{breakdown_D2}≥Vₒᵤₜ.

For example in FIG. 6, the first switch Q₁ has breakdown voltage V_{breakdown_Q1}, the diodes D₁, D₂ on one of the legs have breakdown voltages V_{breakdown_D1}, V_{breakdown_D2}, the diodes D₃, D₄ on the other of the legs have breakdown voltages V_{breakdown_D3}, V_{breakdown_D4}. Assuming V_{breakdown_D1}+V_{breakdown_D2}≥V_{breakdown_D3}+V_{breakdown_D4} and assuming the PV power converter has an output rating as of Vₒᵤₜ, the V_{breakdown_Q1} is selected such that V_{breakdown_Q1}+V_{breakdown_D3}+V_{breakdown_D4}≥Vₒᵤₜ.

Furthermore, for eliminating the fault of short-circuit happening at the outputs of the PV power converter according to an embodiment of present invention, one or more of the legs of the first power conversion circuit 24 will be triggered to a shoot-through state, i.e. both of the semiconductors (e.g. IGBT) in one leg will be switched on. By this way, the fault current injected from the PV panel at the first input terminal Tᵢₙ₁ and second input terminal Tᵢₙ₂ is bypassed by the shoot-through leg instead of rejecting to the DC short circuit point at output ports Pₒᵤₜ₁, Pₒᵤₜ₂. Since the short circuit current at DC input bus side (PV panel) is low, the semiconductors at the shoot-through leg will not experience overcurrent.

A separate bypass switch, which can be either mechanical switch or power semiconductor switch, is parallel connected to the input terminals of the PV power converter. The bypass switch will keep open during normal operation. When there is DC short circuit fault at the output ports, the bypass switch will be closed to bypass the fault current injected from DC input side (PV panel).

Though the present invention has been described on the basis of some preferred embodiments, those skilled in the art should appreciate that those embodiments should by no way limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1. A PV power converter, including:
a transformer;
a first output port and a second output port;
a first power conversion circuit being configured to convert power from PV array into AC power, having:
a first input terminal and a second input terminal being configured to be electrically coupled to outputs of PV array with the second input terminal electrically coupled to the second output port; and
a first output terminal and a second output terminal electrically coupled to primary winding of the transformer;
a second power conversion circuit being configured to convert power from the transformer into DC power, having
a first input end and a second input end electrically coupled to secondary winding of the transformer; and
a first output end electrically coupled to the first output port and a second output end electrically coupled to the first input terminal of the first power conversion circuit;
a first power switch being arranged electrically between either of the first input terminal and the second input terminal and either of the first output port and the second output port, having a conducting direction allowing unidirectional current flow.

2. The PV power converter according to claim 1, wherein:
the second power conversion circuit uses a topology of rectifier having at least one leg of at least one power diode; and
a breakdown voltage of the first power switch is selected such that a sum of the breakdown voltage of the first power and the breakdown voltage of the at least one leg, whichever is lower, is above a predetermined level.

3. The PV power converter according to claim 1, wherein:
the first power switch is arranged between the first input terminal and the second output end.

4. The PV power converter according to claim 1, further including:
the first power switch is arranged between the first output end and the first output port.

5. The PV power converter according to claim 1, wherein:
the first power switch is arranged between the second input terminal and the second output port.

6. The PV power converter according to any of the claims 1 to 5, wherein:
the first power switch uses a power diode.

7. The PV power converter according to any of the claims 1 to 5, further including:
a controller;
wherein:
the first power switch is a controllable power semiconductor device; and
the controller is configured to turn on the first power switch during operation.

8. The PV power converter according to any of the claims 1 to 5, further including:
a controller;
wherein:
the first power conversion circuit uses at least one controllable power switch being configured to bypass power flow from the PV array around the first output port and the second output port when it is in ON state; and
the controller is configured to turn on the at least one controllable power switch when a short current fault is identified concerning the between the first input terminal and the second input terminal.
